(19) United States
(12) Patent Application Publication
(10) Pub. No.: US 2007/0013798 A1
(43) Pub. Date: Jan. 18, 2007

(54) Image sensor with shared voltage converter for global shutter operation

(76) Inventors: Jung-Chak Ahn, Suwon-si (KR); Yong-Hee Lee, Seongnam-si (KR); Jong-Eun Park, Seongnam-si (KR)

Correspondence Address: LAW OFFICE OF MONICA H CHOI, P O BOX 3424, DUBLIN, OH, 430160204, US

(21) Appl. No.: 11/487,283

(22) Filed: Jul. 14, 2006

(30) Foreign Application Priority Data
Jul. 15, 2005 (KR) 2005-64417

(51) Int. Cl. H04N 5/335

(52) U.S. Cl. 348/308

(57) ABSTRACT

Each of a plurality of pixels includes a respective photo-converting unit and a respective charge storing unit. The respective photo-converting unit generates respective charge from an image, and the respective charge storing unit stores the respective charge. The respective charges are generated and stored simultaneously, and converted into respective voltages sequentially by a shared voltage converter.

### BACKGROUND OF THE INVENTION

This application claims priority to Korean Patent Application No. 2005-64417, filed on Jul. 15, 2005 in the Korean Intellectual Property Office, the disclosure of which is incorporated herein in its entirety by reference.

1. Field of the Invention

The present invention relates generally to image sensors, and more particularly to using a shared voltage converter for performing a global shutter operation among a plurality of pixels.

2. Description of the Related Art

Image sensors that convert images into electrical signals are generally classified into one of a charge-coupled device (CCD) type or a complementary metal-oxide-semiconductor (CMOS) type depending on accumulation of electrons or holes and on the mechanism of charge transfer. The CMOS image sensor is also referred to as a CIS.

The CCD-type image sensor transfers accumulated electrons toward an output port using gate pulses for charge coupling and then converts the transferred electrons into a voltage. A photodiode is used in the CCD-type image sensor for photo-conversion of an image to accumulate the electrons. Optical sensitivity is enhanced and noise is reduced when such a photo-diode accumulates the charge carriers for a time for raising the voltage generated with such charge carriers. However, the CCD-type image sensor continuously transfers charge carriers undesirably resulting in high power consumption.

On the other hand, the CMOS image sensor converts charge carriers (i.e., electrons) accumulated from an image into a voltage in each pixel and outputs the voltage through a CMOS switch. The CMOS image sensor is typically weaker in electro-optical characteristics than the CCD image sensor, but has lower power consumption and higher integration density.

However in the CMOS image sensor, as the accumulated charge is converted into a signal voltage in each pixel, noise may arise from transfer of signals to various nodes. In addition, the pixels of the CMOS image sensor each have a respective voltage conversion circuitry resulting in lack of uniformity in conversion of accumulated charge to voltage. Furthermore, such circuitry in each pixel occupies area resulting in less available area for the photo-diode and thus in lower fill-factor.

U.S. Pat. No. 6,107,655 to Guidash discloses sharing some components of the voltage conversion circuitry among multiple pixels for increasing fill-factor in a CMOS image sensor. However, the charge accumulated in the multiple pixels is transferred sequentially from the photo-diodes. Such sequential transfer may result in blurring of image and cannot be used in a global shutter operation for capture of an image uniformly across the array of pixels.

### SUMMARY OF THE INVENTION

Accordingly, an image sensor of embodiments of the present invention has pixels with capability of capturing and storing charge carriers for an image simultaneously by the pixels. Such charge carriers are sequentially transferred and converted into voltages by a shared voltage converter.

An image sensor according to an aspect of the present invention includes a plurality of pixels each including a respective photo-converting unit and a respective charge storing unit. The respective photo-converting unit generates respective charge from an image, and the respective charge storing unit stores the respective charge. The respective charge is generated and stored simultaneously for the pixels. The image sensor also includes a shared voltage converter coupled to each of the pixels for converting the stored respective charge into a respective voltage for each of the pixels.

In one embodiment of the present invention, the respective photo-converting unit is a respective photo-diode, and the respective charge storing unit is a respective capacitor or a respective diode, for each of the pixels.

In another embodiment of the present invention, the image sensor also includes a controller for generating control signals to the pixels such that the respective charges are stored into the respective charge storing units simultaneously for a global shutter operation. Additionally, the controller generates controls signals such that the pixels sequentially transfer the respective charges to the shared voltage converter that generates the respective voltages for the pixels sequentially.

In another embodiment of the present invention, each pixel further includes first and second respective transmission transistors. The first respective transmission transistor is turned on for transferring the respective charge from the photo-converting unit to the respective charge storing unit. The second respective transmission transistor is turned on for transferring the respective charge from the charge storing unit to a floating diffusion region of the shared voltage converter.

In a further embodiment of the present invention, the controller generates control signals for controlling the first respective transmission transistors to turn on simultaneously, and for controlling the second respective transmission transistors of at least two of the pixels having color filters for a same color to turn on simultaneously.

In another embodiment of the present invention, the controller generates control signals such that the second respective transmission transistors of any of the pixels having color filters of different colors are turned on sequentially.

In a further embodiment of the present invention, each pixel further includes a respective over-flow transistor coupled to the photo-converting unit for conducting away a respective overflow charge.

In one example embodiment of the present invention, the shared voltage converter includes a floating diffusion region coupled to each of the pixels, and includes a source follower transistor coupled to the floating diffusion region. Additionally, the shared voltage converter includes a select transistor coupled between the source follower transistor and an output node having the respective voltage generated thereon for each of the pixels.

In another example embodiment of the present invention, the shared voltage converter includes a floating diffusion region coupled to each of the pixels, and includes a reset transistor coupled between the floating diffusion region and a terminal having a drain drive signal applied thereon. In that case, a source follower transistor is coupled to the floating diffusion region, the control terminal, and an output node having the respective voltage generated thereon for each of the pixels.

The present invention may be used to particular advantage when the image sensor is a CMOS (complementary metal oxide semiconductor) image sensor. However, the present invention may also be used for other types of image sensors.

In this manner, the voltage converter is shared among the plurality of pixels for minimizing the area occupied by active components. Thus, the area for the photo-diodes and the fill factor for the pixels may be maximized. Furthermore, because the common voltage converter generates the respective voltage corresponding to the respective accumulated charge for each of the pixels, such respective voltages are generated more uniformly among the pixels.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a CMOS image sensor according to a preferred embodiment of the present invention;

FIG. 2 is a circuit diagram of a plurality of pixels with a shared voltage converter in a pixel array of FIG. 1, according to an embodiment of the present invention;

FIG. 3 is a timing diagram of signals during operation of the components of FIG. 2, according to an embodiment of the present invention;

FIG. 4A is a diagram showing an arrangement of color filters for the pixels of FIG. 2, according to an embodiment of the present invention;

FIG. 4B is a timing diagram of signals for the pixels of FIGS. 2 and 4A, according to an embodiment of the present invention;

FIG. 5 is a circuit diagram of a plurality of pixels with a shared voltage converter in the pixel array of FIG. 1, according to another embodiment of the present invention; and

FIG. 6 is a block diagram of components of a controller in the CMOS image sensor of FIG. 1, according to an embodiment of the present invention.

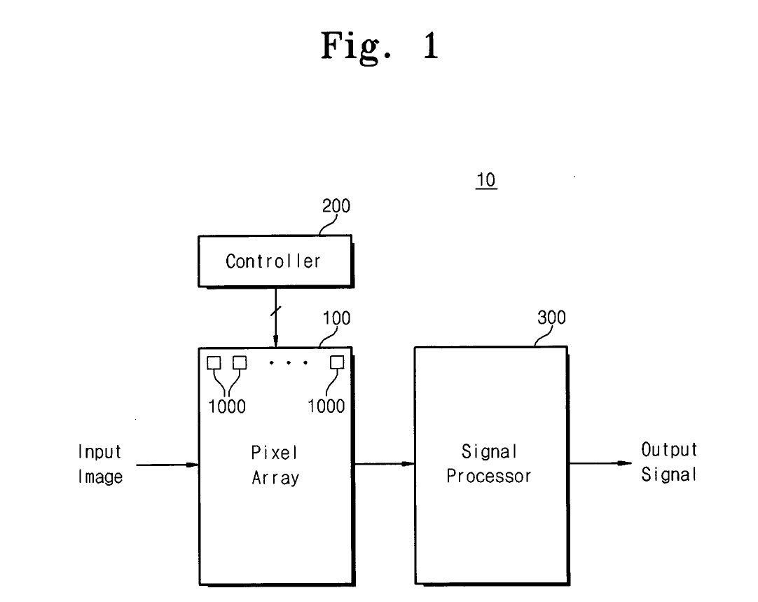

The figures referred to herein are drawn for clarity of illustration and are not necessarily drawn to scale. Elements having the same reference number in FIGS. 1, 2, 3, 4, 5, and 6 refer to elements having similar structure and/or function.

### DETAILED DESCRIPTION OF THE INVENTION

FIG. 1 is a block diagram of a CMOS (complementary metal oxide semiconductor) image sensor in accordance with a preferred embodiment of the present invention. The CMOS image sensor 10 includes a pixel array 100, a controller 200, and a signal processor 300. The pixel array 100 includes rows and columns of pixels for converting an image into electrical signals. Each pixel photo-converts light of the image to generate a respective voltage at a respective location of the array.

The controller 200 generates control signals for driving the pixels of the pixel array 100. The signal processor 300 converts the respective voltages from the pixels of the pixel array 100 including converting an analog voltage into a digital signal with removal of noise.

In one embodiment of the present invention, the pixel array 100 is comprised of an array of active pixel sensor (APS) units 1000, each having multiple pixels sharing a voltage converter.

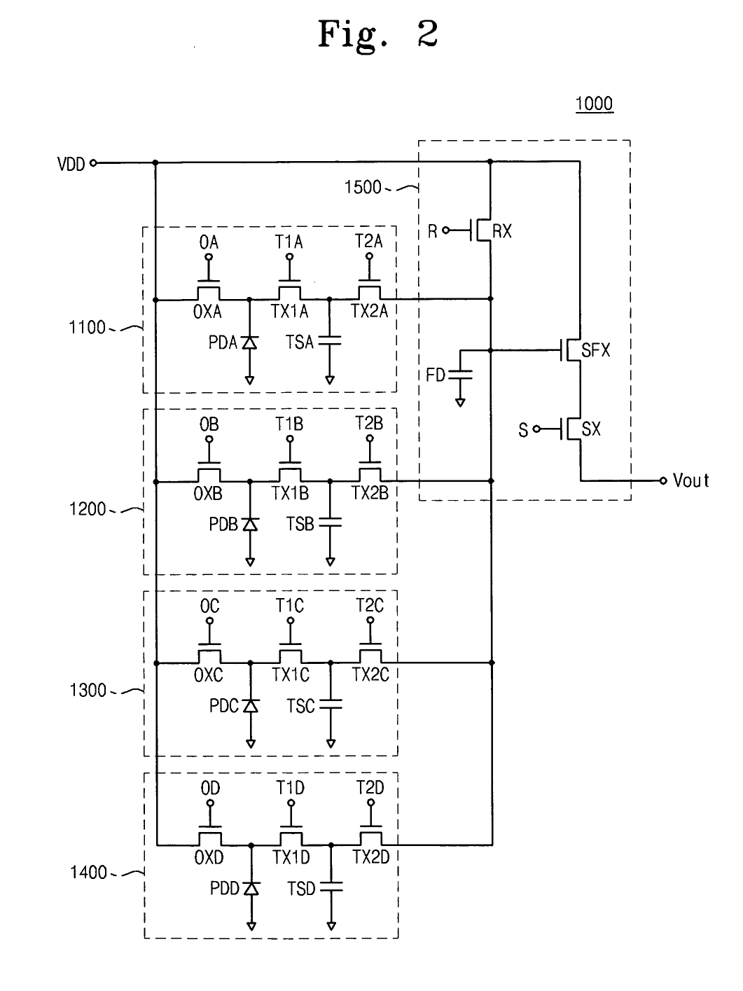

FIG. 2 shows a circuit diagram for one example APS unit 1000 that performs a global shutter operation. The APS unit 1000 includes a plurality of pixels including a first pixel 1100, a second pixel 1200, a third pixel 1300, and a fourth pixel 1400. In addition, the APS unit 1000 also includes a shared voltage converter 1500 coupled to each of the pixels 1100, 1200, 1300, and 1440.

For the global shutter operation, charge is desired to be accumulated within each of the pixels 1100, 1200, 1300, and 1440 simultaneously. Thus, even when the image is for a fast-moving object, the image captured by the pixel array 100 is not prone to trembling or blurring.

Each of the pixels 1100, 1200, 1300, and 1440 includes a respective photodiode PD which is an example photo-converting unit and a respective capacitor or diode TS which is an example charge storing unit. Thus, the pixels 1100, 1200, 1300, and 1440 have the photo-diodes PDA, PDB, PDC, and PDD, respectively, and have the charge storing units TSA, TSB, TSC, and TSD, respectively.

Furthermore, each of the pixels 1100, 1200, 1300, and 1440 includes a respective over-flow protection transistor OX, a respective first transmission transistor TX1, and a respective second transmission transistor TX2. Thus, the pixels 1100, 1200, 1300, and 1440 have the over-flow protection transistors OXA, OXB, OXC, and OXD, respectively, and have the first transmission transistors TX1A, TX1B, TX1C, and TX1D, respectively, and have the second transmission transistors TX2A, TX2B, TX2C, and TX2D, respectively.

The coupling of such components in the example pixel 1100 is now described, and such configuration is similar for the other pixels 1200, 1300, and 1400. The drain and source of the overflow protection transistor OXA are coupled between a high power supply node VDD and the photo-diode PDA. A control signal OA is applied on the gate of the overflow protection transistor OXA.

The drain and source of the first transmission transistor TX1A are coupled between the photo-diode PDA and the capacitor TSA. A control signal T1A is applied on the gate of the first transmission transistor TX1A. The drain and source of the second transmission transistor TX2A are coupled between the charge storing unit TSA and the shared voltage converter 1500. A control signal T2A is applied on the gate of the second transmission transistor TX2A.

The other pixels 1200, 1300, and 1400 have similar configuration of the corresponding components therein.

The voltage converter 1500 is shared among the pixels 1100, 1200, 1300, and 1400 and sequentially generates a respective voltage corresponding to a respective charge accumulated in each of the pixels, 1100, 1200, 1300, and 1400. The voltage converter 1500 includes a reset transistor RX, a floating diffusion region FD, a source follower transistor SFX, and a selection transistor SX.

The drain and source of reset transistor RX are coupled between a high power supply node VDD and the floating diffusion region FD. The gate of the reset transistor RX has a control signal R applied thereon. The drain and source of the source follower transistor SFX are coupled between the high power supply node VDD and the selection transistor SX. The gate of the source follower transistor SFX is coupled to the floating diffusion region FD.

One drain/source of the selection transistor SX forms an output node having a voltage Vout generated thereon. The voltage Vout corresponds to the accumulated charge from one of the pixels 1100, 1200, 1300, and 1400.

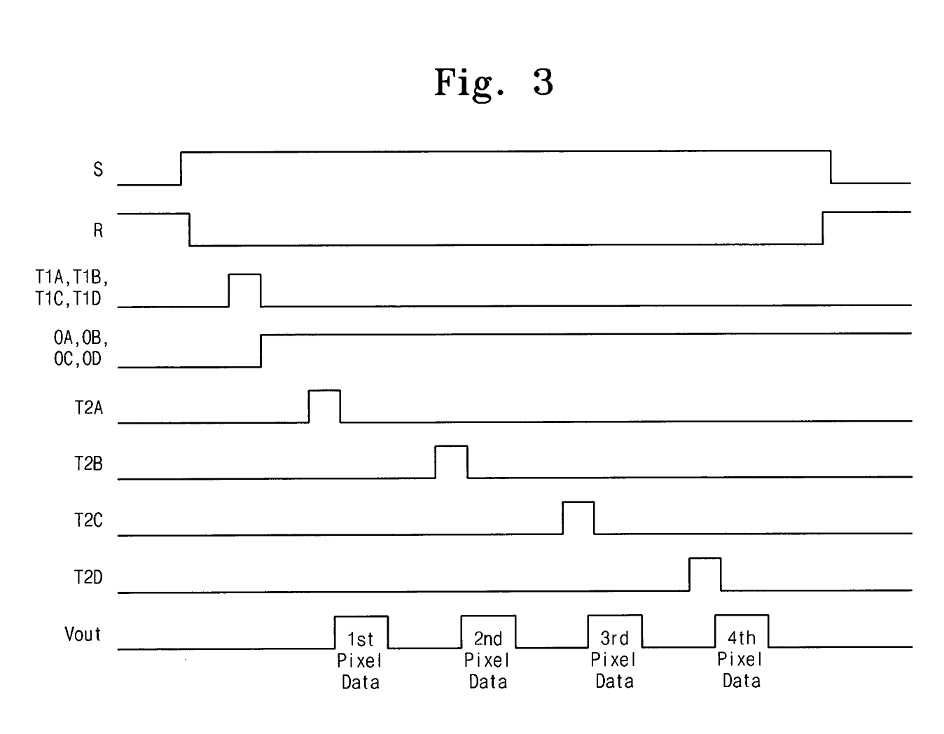

Operation of the APS unit 1000 is now described with reference to the timing diagram of FIG. 3. Referring to FIGS. 2 and 3, the control signal R is initially activated to logic high for resetting the floating diffusion region FD via the reset transistor RX. The control signal S is activated to logic high for turning on the selection transistor SX indicating that the APS unit 1000 is being selected for data output.

Shortly after the control signal S is activated, the control signal R is deactivated for turning off the reset transistor RX. In addition, each of the photo-diodes PDA, PDB, PDC, and PDD photo-converts light corresponding to an image to generate respective charge corresponding to the intensity of such light at a respective location in the pixel array 100.

Further referring to FIGS. 2 and 3, after the control signal R is deactivated, the controls signals T1A, T1B, T1C, and T1D to the first transmission transistors TX1A, TX1B, TX1C, and TX1D are simultaneously activated for a pulse period. During such activation, the first transmission transistors TX1A, TX1B, TX1C, and TX1D simultaneously turn on. Thus, the respective charges accumulated by the photo-diodes PDA, PDB, PDC, and PDD are simultaneously transferred through the first transmission transistors TX1A, TX1B, TX1C, and TX1D, respectively, to the charge storing units TSA, TSB, TSC, and TSD, respectively.

Thereafter, the control signals OA, OB, OC, and OD are activated to logic high for turning on the over-flow protection transistors OXA, OXB, OXC, and OXD, respectively. Such over-flow protection transistors OXA, OXB, OXC, and OXD turn on to conduct away any excess undesired charge (i.e., overflow charge) accumulated by the photo-diodes PDA, PDB, PDC, and PDD, respectively.

Subsequently, each of the control signals T2A, T2B, T2C, and T2D are activated with a logic high pulse sequentially. For example in FIG. 3, the control signal T2A for the first pixel 1100 is activated with a logic high pulse such that the second transmission transistor TX2A is turned on for transferring the charge stored in the charge storing unit TSA to the floating diffusion node FD. The voltage converter 1500 then generates the respective voltage Vout corresponding to such transferred charge from the first pixel 1100 as first pixel data.

Thereafter in FIG. 3, the control signal T2B for the second pixel 1200 is activated with a logic high pulse such that the second transmission transistor TX2B is turned on for transferring the charge stored in the charge storing unit TSB to the floating diffusion node FD. The voltage converter 1500 then generates the respective voltage Vout corresponding to such transferred charge from the second pixel 1200 as second pixel data.

Subsequently in FIG. 3, the control signal T2C for the third pixel 1300 is activated with a logic high pulse such that the second transmission transistor TX2C is turned on for transferring the charge stored in the charge storing unit TSC to the floating diffusion node FD. The voltage converter 1500 then generates the respective voltage Vout corresponding to such transferred charge from the third pixel 1300 as third pixel data.

Finally in FIG. 3, the control signal T2D for the fourth pixel 1400 is activated with a logic high pulse such that the second transmission transistor TX2D is turned on for transferring the charge stored in the charge storing unit TSD to the floating diffusion node FD. The voltage converter 1500 then generates the respective voltage Vout corresponding to such transferred charge from the fourth pixel 1400 as fourth pixel data.

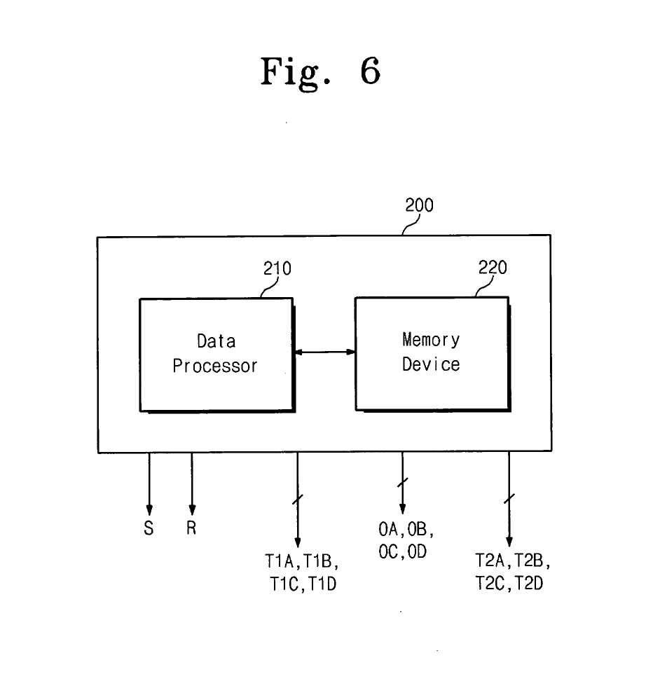

Referring to FIGS. 3 and 6, the controller 200 generates the control signals S, R, T1A, T1B, T1C, T1D, OA, OB, OC, OD, T2A, T2B, T2C, and T2D of FIG. 3, in one embodiment of the present invention. The controller 200 includes a data processor 210 and a memory device 220 having sequences of instructions stored thereon. Execution of such sequences of instructions by the data processor 210 causes the data processor 210 to perform any functions of the controller 200 as described herein such as generating the control signals S, R, T1A, T1B, T1C, T1D, OA, OB, OC, OD, T2A, T2B, T2C, and T2D.

In this manner, the multiple pixels 1100, 1200, 1300, and 1400 share the voltage converter 1500. Thus, the active devices of the voltage converter 1500 are not included into each of the pixels 1100, 1200, 1300, and 1400 for saving area such that the area of the photo-diodes PDA, PDB, PDC, and PDD may be increased for maximizing fill factor. Furthermore, the common voltage converter 1500 generates the respective voltages for charges accumulated by the pixels 1100, 1200, 1300, and 1400 uniformly.

In addition, because the accumulated charges from the photo-diodes PDA, PDB, PDC, and PDD are transferred to the charge storing units TSA, TSB, TSC, and TSD simultaneously for global shutter operation, the captured image is not trembling or blurred even for fast-moving objects. Furthermore, the sequential transfer of the charges from the charge storing units TSA, TSB, TSC, and TSD to the floating diffusion region FD prevents charge mingling between the photodiodes PDA, PDB, PDC, and PDD.

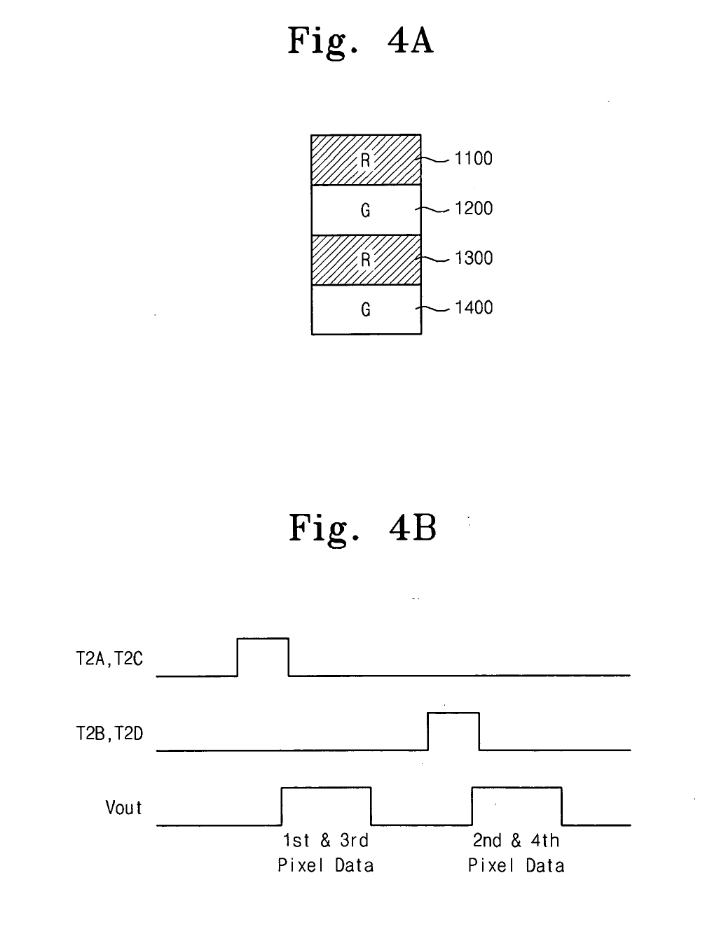

FIG. 4A illustrates arrangement of the pixels 1100, 1200, 1300, and 1400 according to a respective color of a color filter for each of such pixels. The first and third pixels 1100 and 1300 have color filters for accepting light of the red color. The second and fourth pixels 1200 and 1400 have color filters for accepting light of the green color.

FIG. 4B is a timing diagram of the second transmission control signals T2A, T2B, T2C, and T2D according to an alternative embodiment of the present invention. In such an alternative embodiment, the second transmission control signals T2A and T2C for the pixels 1100 and 1300 having color filters for the same color (i.e., red) are simultaneously activated for a logic high period. Thus, the respective accumulated charges from such pixels 1100 and 1300 are simultaneously transferred to the floating diffusion region FD for voltage conversion by the shared voltage converter 1500.

Similarly, the second transmission control signals T2B and T2D for the pixels 1200 and 1400 having color filters for the same color (i.e., green) are simultaneously activated for a logic high period. Thus, the respective accumulated charges from such pixels 1200 and 1400 are simultaneously transferred to the floating diffusion region FD for voltage conversion by the shared voltage converter 1500.

In the case of FIG. 4B, the voltage Vout generated by the voltage converter 1500 represents an average of the respective accumulated charges from such multiple pixels of same color. The logic high pulse for the first and third pixels 1100 and 1300 is generated first for the corresponding average voltage Vout (i.e., the 1^{st} and 3^{rd} pixel data in FIG. 4B). Subsequently, the logic high pulse for the second and fourth pixels 1200 and 1400 is generated for the corresponding average voltage Vout (i.e., the 2^{nd} and 4^{th} pixel data in FIG. 4B).

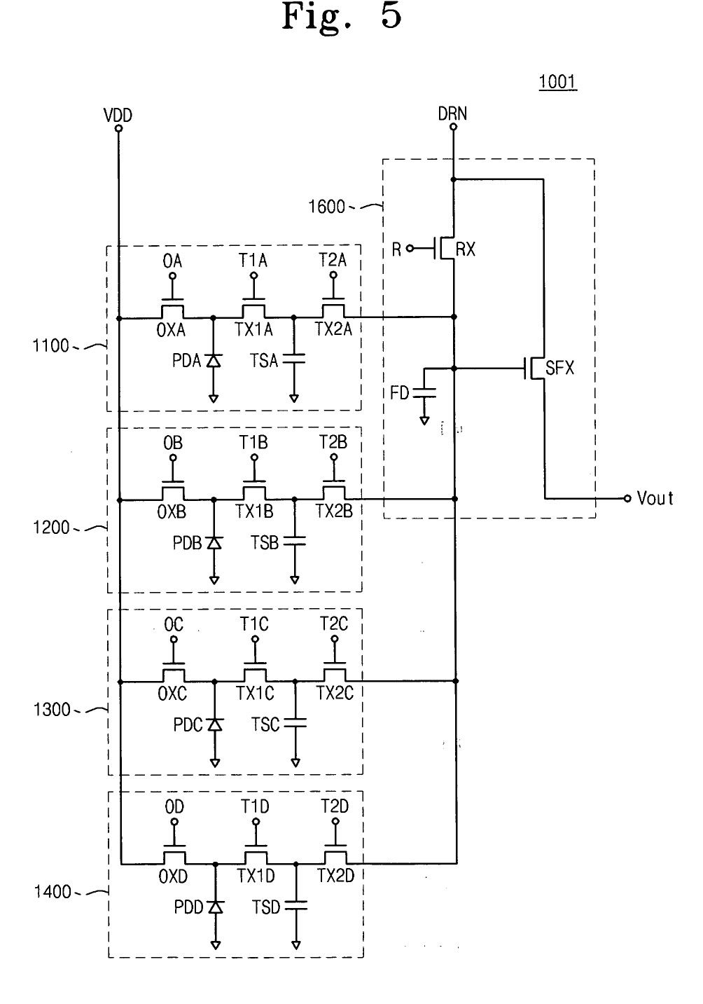

FIG. 5 is a circuit diagram of an APS unit 1001 according to an alternative embodiment of the present invention. Elements having the same reference number in FIGS. 2 and 5 refer to elements having similar structure and/or function. Thus, the APS unit 1001 of FIG. 5 is similar to the APS unit 1000 of FIG. 2.

However, the APS unit 1001 of FIG. 5 has a differently configured shared voltage converter 1600. The shared voltage converter 1600 does not have the selection transistor SX of FIG. 2. Rather, one drain/source of the source follower transistor SFX has the output voltage Vout generated thereon. In addition, the other drain/source of the source follower transistor SFX and one drain/source of the reset transistor RX has a drain drive signal DRN applied thereon. Such a control signal DRN may be generated by the controller 200.

Otherwise, the APS unit 1001 of FIG. 5 operates similarly to the APS unit 1000 of FIG. 2 for simultaneously transferring the respective accumulated charges from the photodiodes PDA, PDB, PDC, and PDD to the charge storing units TSA, TSB, TSC, and TSD. Thereafter, such respective charges are sequentially transferred and converted into respective voltages by the shared voltage converter 1600 of FIG. 5.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, any specified numbers or number of elements or type of devices illustrated and described herein are by way of example only.

In addition, the present invention has been described for application within a CMOS image sensor. However, aspects of the present invention may advantageously be applied in any type of image sensor.

The present invention is limited only as defined in the following claims and equivalents thereof.

What is claimed is:

1. An image sensor comprising:
a plurality of pixels, each pixel including:
a respective photo-converting unit for generating respective charge from an image; and
a respective charge storing unit for storing the respective charge;
wherein the respective charge is generated and stored simultaneously for the pixels; and
a shared voltage converter coupled to each of the pixels for converting the stored respective charge into a respective voltage for each of the pixels.

2. The image sensor of claim 1, wherein the respective photo-converting unit is a respective photo-diode, and wherein the respective charge storing unit is a respective capacitor or a respective diode.

3. The image sensor of claim 1, further comprising:
a controller for generating control signals to the pixels such that the respective charges are stored into the respective charge storing units simultaneously for a global shutter operation.

4. The image sensor of claim 1, further comprising:
a controller for generating controls signals to the pixels and the shared voltage converter such that the pixels sequentially transfer the respective charges to the shared voltage converter that generates the respective voltages for the pixels sequentially.

5. The image sensor of claim 1, wherein each pixel further includes:
a first respective transmission transistor that is turned on for transferring the respective charge from the photo-converting unit to the respective charge storing unit; and
a second respective transmission transistor that is turned on for transferring the respective charge from the charge storing unit to a floating diffusion region of the shared voltage converter.

6. The image sensor of claim 5, further comprising:
a controller that generates control signals for controlling the first respective transmission transistors to turn on simultaneously, and for controlling the second respective transmission transistors to turn on sequentially.

7. The image sensor of claim 5, further comprising:
a controller that generates control signals for controlling the first respective transmission transistors to turn on simultaneously, and for controlling the second respective transmission transistors of at least two of the pixels having color filters for a same color to turn on simultaneously.

8. The image sensor of claim 7, wherein the controller generates control signals such that the second respective transmission transistors of any of the pixels having color filters of different colors are turned on sequentially.

9. The image sensor of claim 1, wherein each pixel further includes:
a respective over-flow transistor coupled to the photo-converting unit for conducting away a respective overflow charge.

10. The image sensor of claim 1, wherein the shared voltage converter includes:
a floating diffusion region coupled to each of the pixels;
a reset transistor coupled between the floating diffusion region and a power supply node;
a source follower transistor coupled to the floating diffusion region; and
a select transistor coupled between the source follower transistor and an output node having the respective voltage generated thereon for each of the pixels.

11. The image sensor of claim 1, wherein the shared voltage converter includes:
a floating diffusion region coupled to each of the pixels;
a reset transistor coupled between the floating diffusion region and a terminal having a drain drive signal applied thereon; and
a source follower transistor coupled to the floating diffusion region, the terminal having the drain drive signal applied thereon, and an output node having the respective voltage generated thereon for each of the pixels.

12. The image sensor of claim 1, wherein the image sensor is a CMOS (complementary metal oxide semiconductor) image sensor.

13. A method of sensing an image comprising:
photo-converting the image into a respective charge at each of a plurality of pixels simultaneously;
transferring and storing the respective charge into a respective charge storing unit for each of the pixels simultaneously; and
converting the respective charge into a respective voltage using a same shared voltage converter for each of the pixels.

14. The method of claim 13, wherein a respective photo-diode generates the respective charge within each of the pixels.

15. The method of claim 14, wherein the respective charge storing unit is a respective capacitor or a respective diode coupled to the respective photo-diode via a respective transmission transistor.

16. The method of claim 13, further comprising:
converting the respective charges into the respective voltages for the pixels sequentially.

17. The method of claim 13, further comprising:
transferring the respective charges of at least two of the pixels having color filters for a same color to a floating diffusion region of the shared voltage converter simultaneously.

18. The method of claim 17, further comprising:
transferring the respective charges of any of the pixels having color filters for different colors to the floating diffusion region sequentially.

19. The method of claim 13, further comprising:
conducting away respective overflow charge within each of the pixels.

20. The method of claim 13, wherein the image sensor is a CMOS (complementary metal oxide semiconductor) image sensor.
